(19) United States
(12) Patent Application Publication
(10) Pub. No.: US 2017/0366094 A1
(43) Pub. Date: Dec. 21, 2017

(54) POWER SUPPLY APPARATUS AND ELECTRONIC DEVICE

(71) Applicant: FUJITSU LIMITED, Kawasaki-shi (JP)

(72) Inventors: Takahiko Sugawara, Kawasaki (JP); Hiroshi Nakao, Yamato (JP); Yu Yonezawa, Sagamihara (JP); Yoshiyasu Nakashima, Kawasaki (JP)

(73) Assignee: FUJITSU LIMITED, Kawasaki-shi (JP)

(21) Appl. No.: 15/612,438

(22) Filed: Jun. 2, 2017

(30) Foreign Application Priority Data
Jun. 21, 2016 (JP) 2016-122993

(51) Int. Cl. H02M 3/335

(52) U.S. Cl. CPC H02M 3/33546; H02M 3/33515

(57) ABSTRACT

A power supply apparatus includes a DC-DC converter configured to convert an input voltage into an output voltage in accordance with a duty cycle which is decided by a difference of a third signal, a first photo coupler configured to output a first signal corresponding to the output voltage, a converter configured to convert the output voltage into a digital signal, and a second photo coupler configured to output a second signal corresponding to the digital signal, a memory, and a processor coupled to the memory and configured to calculate a third signal on the basis of the difference between the first signal and the second signal, and control the DC-DC converter so that the third signal is to be zero.

### CROSS-REFERENCE TO RELATED APPLICATION

This application is based upon and claims the benefit of priority of the prior Japanese Patent Application No. 2016-122993, filed on Jun. 21, 2016, the entire contents of which are incorporated herein by reference.

### FIELD

The embodiments discussed herein are related to a power supply apparatus and an electronic device.

### BACKGROUND

Traditionally, a DC-DC converter, which includes a photo coupler for transferring, as a feedback signal, a digital signal obtained based on an output voltage and a digital control circuit for controlling the output voltage to a fixed value based on the feedback signal, is known (refer to, for example, Japanese Laid-open Patent Publication No. 2009-11050).

### SUMMARY

According to an aspect of the invention, a power supply apparatus includes a DC-DC converter configured to convert an input voltage into an output voltage in accordance with a duty cycle which is decided by a difference of a third signal, a first photo coupler configured to output a first signal corresponding to the output voltage, a converter configured to convert the output voltage into a digital signal, and a second photo coupler configured to output a second signal corresponding to the digital signal, a memory, and a processor coupled to the memory and configured to calculate a third signal on the basis of the difference between the first signal and the second signal, and control the DC-DC converter so that the third signal is to be zero.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of the configuration of a power supply apparatus configured to generate an output voltage from an input voltage by switching of a switching element;

FIG. 2 is a diagram illustrating an example of changes in a value output from a detecting circuit;

FIG. 3 is a diagram illustrating an example of the configuration of a power supply apparatus according to a first embodiment;

FIG. 4 is a diagram illustrating in detail an example of the configuration of a controller included in the power supply apparatus according to the first embodiment;

FIG. 5 is a diagram illustrating an example of the configuration of a power supply apparatus according to a second embodiment;

FIG. 6 is a diagram illustrating in detail an example of the configuration of a controller included in the power supply apparatus according to the second embodiment;

FIG. 7 is a flowchart of an example of a main control process to be executed by a microcomputer;

FIG. 8 is a flowchart of an example of a process of acquiring an error voltage;

FIG. 9 is a flowchart of an example of a process of calculating a compensation value;

FIG. 10 is a flowchart of an example of a correction process to be executed by an AD converter;

FIG. 11 is a flowchart of an example of a correction process to be executed by the microcomputer and the AD converter;

FIG. 12 is a flowchart of an example of a steady state monitoring process;

FIG. 13 is a flowchart of an example of a process of calculating and applying correction values;

FIG. 14 is a diagram illustrating an example of the relationship between time and a correction value;

FIG. 15 is a flowchart of an example of a process of estimating life;

FIG. 16 is a diagram illustrating an example of a display state;

FIG. 17 is a diagram illustrating an example of the display state; and

FIG. 18 is a diagram illustrating an example of the display state.

### DESCRIPTION OF EMBODIMENTS

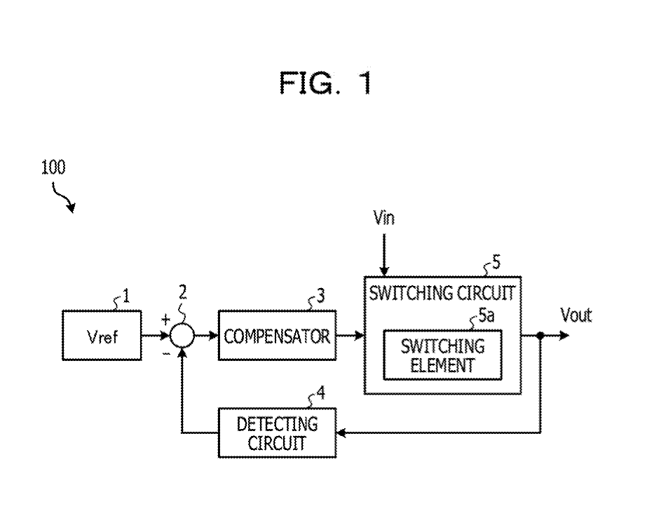

FIG. 1 is a block diagram illustrating an example of the configuration of a power supply apparatus 100 configured to generate an output voltage from an input voltage by switching of a switching element. The power supply apparatus 100 includes a switching circuit 5, a detecting circuit 4, a target voltage setting section 1, an error calculator 2, and a compensator 3. The switching circuit 5 includes the switching element 5a and converts an input voltage Vin into an output voltage Vout by the switching of the switching element 5a. The detecting circuit 4 detects the output voltage Vout output from the switching circuit 5 and outputs the value of the detected output voltage Vout via a photo coupler. The target voltage setting section 1 sets a target value Vref of the output voltage Vout. The error calculator 2 calculates the difference between the target value Vref set by the target voltage setting section 1 and the value of the output voltage Vout output from the detecting circuit 4. The compensator 3 controls a duty ratio of the switching of the switching element 5a so that the difference becomes zero.

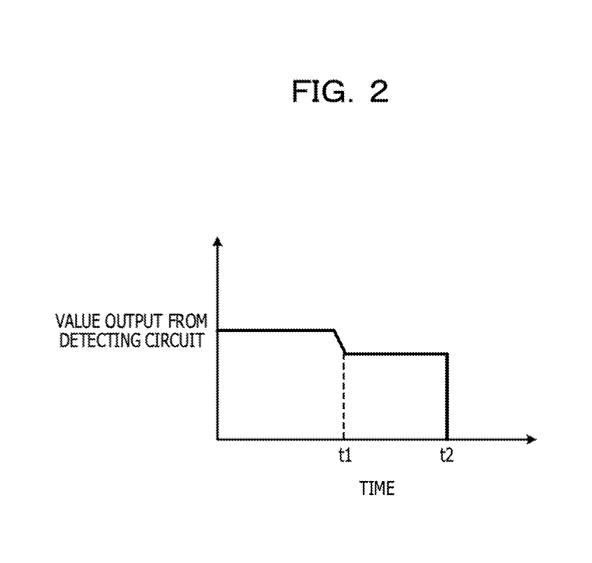

If a line between the switching circuit 5 and the detecting circuit 4 is disconnected in the power supply apparatus 100 illustrated in FIG. 1, the value output from the detecting circuit 4 becomes zero (refer to, for example, a time t2 illustrated in FIG. 2) and it may be determined that an abnormality caused by the disconnection of the line has occurred in the power supply apparatus 100. FIG. 2 is a diagram illustrating an example of changes in the value output from the detecting circuit 4.

However, if the photo coupler included in the detecting circuit 4 has degraded, a gain of the detecting circuit 4 changes and the value output from the detecting circuit 4 changes. Thus, if the voltage output from the detecting circuit 4 changes to a value other than zero (refer to, for example, a time t1 illustrated in FIG. 2), it is difficult to determine whether the value output from the detecting circuit 4 has changed due to a change in the output voltage Vout or due to the degradation of the photo coupler.

Thus, if the value output from the detecting circuit 4 changes due to the degradation of the photo coupler, the output voltage Vout is changed by the compensator 3 based on the change in the value output from the detecting circuit 4 and it is difficult to maintain the output voltage Vout at a fixed value.

Thus, an aspect of the present disclosure aims to maintain an output voltage of a power supply apparatus at a fixed value even if a photo coupler has degraded.

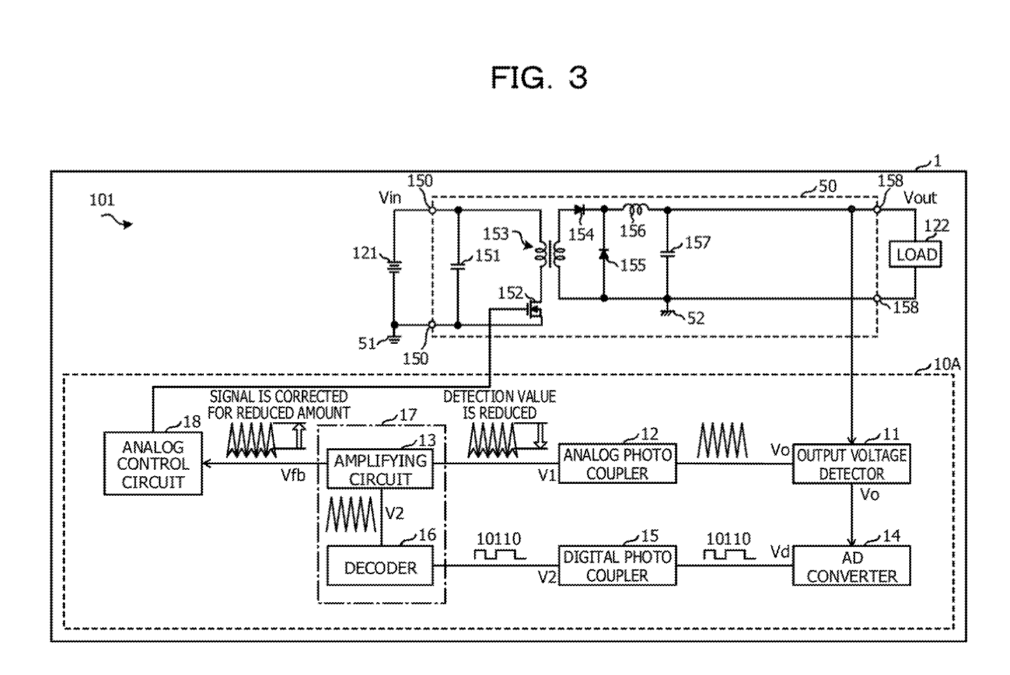

FIG. 3 is a diagram illustrating an example of the configuration of a power supply apparatus 101 according to a first embodiment. The power supply apparatus 101 is an example of a switching power supply configured to generate a direct-current output voltage Vout from a direct-current input voltage Vin by switching of a switching element 152 included in a switching circuit 50. The switching circuit 50 is an example of an isolated DC-DC converter configured to convert the input voltage Vin into the output voltage Vout. DC is an abbreviation of direct current.

The power supply apparatus 101 supplies the fixed output voltage Vout to a load 122 included in an electronic device 1 or to loads 122 included in the electronic device 1. The power supply apparatus 101 may be included in the electronic device 1 or arranged output the electronic device 1. Examples of the electronic device 1 are a motherboard, a communication base station, a server, a mobile terminal device, and a personal computer. Examples of the mobile terminal device is a mobile phone and a smartphone. The electronic device 1 is not limited to these examples.

The power supply apparatus 101 includes the switching circuit 50. The switching circuit 50 includes the switching element 152 and is an example of a converting circuit configured to convert the input voltage Vin input to the switching circuit 50 into the output voltage Vout by the switching of the switching element 152. The switching circuit 50 converts the direct-current input voltage Vin into the direct-current output voltage Vout and outputs the direct-current output voltage Vout after the voltage conversion. Examples of the switching element 152 are a bipolar transistor and a field-effect transistor.

The switching circuit 50 includes a pair of input terminals 150, a pair of output terminals 158, the switching element 152, a transformer 153, capacitors 151 and 157, diodes 154 and 155, and an inductor 156 and is an example of a known forward converter.

The switching circuit 50 converts the input voltage Vin input from a direct-current input power supply 121 to the pair of the input terminals 150 located on the primary side of the transformer 153 into the output voltage Vout to be output from the pair of the output terminals 158 located on the secondary side of the transformer 153. In other words, the switching circuit 50 converts the input voltage Vin with respect to a primary-side ground 51 as a reference into the output voltage Vout with respect to a secondary-side ground 52 as a reference by the switching of the switching element 152 coupled to a primary-side coil of the transformer 153. The output voltage Vout is applied to the load 122 via the pair of output terminals 158.

The power supply apparatus 101 includes a controller 10A. The controller 10A controls a switching operation of the switching circuit 50. The controller 10A includes an output voltage detector 11, an analog photo coupler 12, an analog-to-digital (AD) converter 14, a digital photo coupler 15, a corrector 17, and an analog control circuit 18, for example.

The output voltage detector 11 detects the value of the output voltage Vout output from the switching circuit 50 and outputs an analog signal Vo indicating the detected voltage value. For example, the output voltage detector 11 divides the output voltage Vout based on resistors and outputs the analog signal Vo. The analog signal Vo is input to the analog photo coupler 12 and the AD converter 14. The output voltage Vout may be input as the analog signal Vo directly to the analog photo coupler 12 or the AD converter 14 or directly to the analog photo coupler 12 and the AD converter 14.

The analog photo coupler 12 transfers the analog signal Vo as an analog first voltage detection signal V1 to the corrector 17. The analog photo coupler 12 electrically isolates the analog signal Vo by converting the analog signal Vo into light and transfers the analog signal Vo as the analog first voltage detection signal V1. The analog photo coupler 12 is an example of a first photo coupler. The first voltage detection signal V1 is an example of a first signal.

The AD converter 14 is an example of a converter configured to convert the analog signal Vo indicating the value of the output voltage Vout into a digital signal Vd. The AD converter 14 converts the analog signal Vo into the digital signal Vd and transfers the digital signal Vd in serial transmission, for example.

The digital photo coupler 15 transfers the digital signal Vd as a digital second voltage detection signal V2 to the corrector 17. The digital photo coupler 15 electrically isolates the digital signal Vd by converting the digital signal Vd into light and transfers the digital signal Vd as the digital second voltage detection signal Vd. The digital photo coupler 15 is an example of a second photo coupler. The second voltage detection signal V2 is an example of a second signal.

The analog first voltage detection signal V1 is the analog signal Vo that changes based on a change in the output voltage Vout and is transferred by the analog photo coupler 12 in analog transmission. Thus, the analog first voltage detection signal V1 is sensitive to a reduction in the sensitivity of the analog photo coupler 12. On the other hand, a value indicated by the digital signal Vd is “0” or “1”. Thus, the second voltage detection signal V2 output from the digital photo coupler 15 may be detected based on the determination of whether the second voltage detection signal V2 is higher or lower than a threshold determined upon design. Thus, if the threshold is set to a value having a margin sufficient for a voltage corresponding to “0” or “1”, the second voltage detection signal V2 is not erroneously detected even upon a reduction in the sensitivity of the digital photo coupler 15. The degree (degree at which a transferred detail changes due to the degradation of the digital photo coupler 15) at which the performance of the digital transfer is reduced is much smaller than the degree (degree at which a transferred detail changes due to the degradation of the analog photo coupler 12) at which the performance of the analog transfer is reduced.

As the degree at which the analog photo coupler 12 degrades increases, the current transfer ratio (CTR) of the analog photo coupler 12 is reduced and a current output as the first voltage detection signal V1 from the analog photo coupler 12 decreases. Specifically, the value indicated by the first voltage detection signal V1 is reduced. As described above, the degree at which the performance of the digital transfer by the digital photo coupler 15 is reduced is much smaller than the degree at which the performance of the analog transfer by the analog photo coupler 12 is reduced. Thus, as the degree at which the analog photo coupler 12 degrades increases, the absolute value of the difference (hereinafter also referred to as difference E) between the value indicated by the first voltage detection signal V1 and the value indicated by the second voltage detection signal V2 becomes larger.

Thus, the corrector 17 corrects, based on the difference E, the first voltage detection signal V1 output from the analog photo coupler 12. Then, the analog control circuit 18 controls the switching circuit 50 based on the first voltage detection signal V1 corrected based on the difference E so that the output voltage Vout is maintained at a fixed value. Since the switching circuit 50 is controlled based on the first voltage detection signal V1 corrected based on the difference E so that the output voltage Vout is maintained at the fixed value, the output voltage Vout may be maintained at the fixed value even upon the degradation of the analog photo coupler 12.

The value indicated by the first voltage detection signal V1 indicates the value (voltage value detected by the analog photo coupler 12), detected by the analog photo coupler 12, of the output voltage Vout. The value indicated by the second voltage detection signal V2 indicates the value (voltage value detected by the digital photo coupler 15), detected by the digital photo coupler 15, of the output voltage Vout.

The corrector 17 corrects the first voltage detection signal V1 based on the difference E and outputs, as a feedback signal Vfb, the first voltage detection signal V1 corrected based on the difference E. The corrector 17 corrects the first voltage detection signal V1 output from the analog photo coupler 12 by adding a value corresponding to the difference E to the first voltage detection signal V1 output from the analog photo coupler 12 and outputs the feedback signal Vfb.

The analog control circuit 18 controls the switching circuit 50 based on the feedback signal Vfb so that the output voltage Vout is maintained at the fixed value. For example, the analog control circuit 18 controls the duty ratio of the switching of the switching element 152 so that the difference between a fixed target value (hereinafter referred to as “target value Vref”) of the output voltage Vout and the value indicated by the feedback signal Vfb becomes zero.

The digital photo coupler 15 is used as a photo coupler for monitoring the degradation of the analog photo coupler 12. Since photo couplers gradually degrade, intervals at which the degradation of the analog photo coupler 12 is monitored may be relatively long (or intervals of, for example, one day). Thus, even if intervals at which the digital photo coupler 15 transfers the digital signal Vd are longer than intervals at which the analog photo coupler 12 transfers the analog signal Vo, the degradation of the analog photo coupler 12 over time may be sufficiently monitored.

In order to determine the degradation of the analog photo coupler 12, it is sufficient if the digital signal Vd is transferred one or more times for the calculation of the difference E. Thus, a photo coupler whose transfer rate is lower than that of the analog photo coupler 12 may be used as the digital photo coupler 15, and the cost of the digital photo coupler 15 and power to be consumed by the digital photo coupler 15 may be reduced. Units of the transfer rates may be expressed by Mbps, for example. Similarly, an AD converter whose conversion rate is relatively low may be used as the AD converter 14, and the cost of the AD converter 14 and power to be consumed by the AD converter 14 may be reduced.

The controller 10A may include a blocker configured to block a power supply voltage to be supplied to the AD converter 14 or the digital photo coupler 15 or to the AD converter 14 and the digital photo coupler 15 for a time period for which the digital photo coupler 15 does not transfer the digital signal Vd. This blocking may suppress power to be consumed by the power supply apparatus 101 and the electronic device 1.

The corrector 17 corrects the first voltage detection signal V1 by an analog amplifying circuit 13, for example. The corrector 17 includes the amplifying circuit 13 and a decoder 16, for example. The amplifying circuit 13 amplifies the first voltage detection signal V1 and outputs, as the feedback signal Vfb, a signal obtained by amplifying the first voltage detection signal V1. The decoder 16 decodes the digital second voltage detection signal V2 and converts the digital second voltage detection signal V2 into an analog second voltage detection signal V2. The amplifying circuit 13 amplifies the first voltage detection signal V1 output from the analog photo coupler 12 by a gain (amplification degree) adjusted based on the difference E.

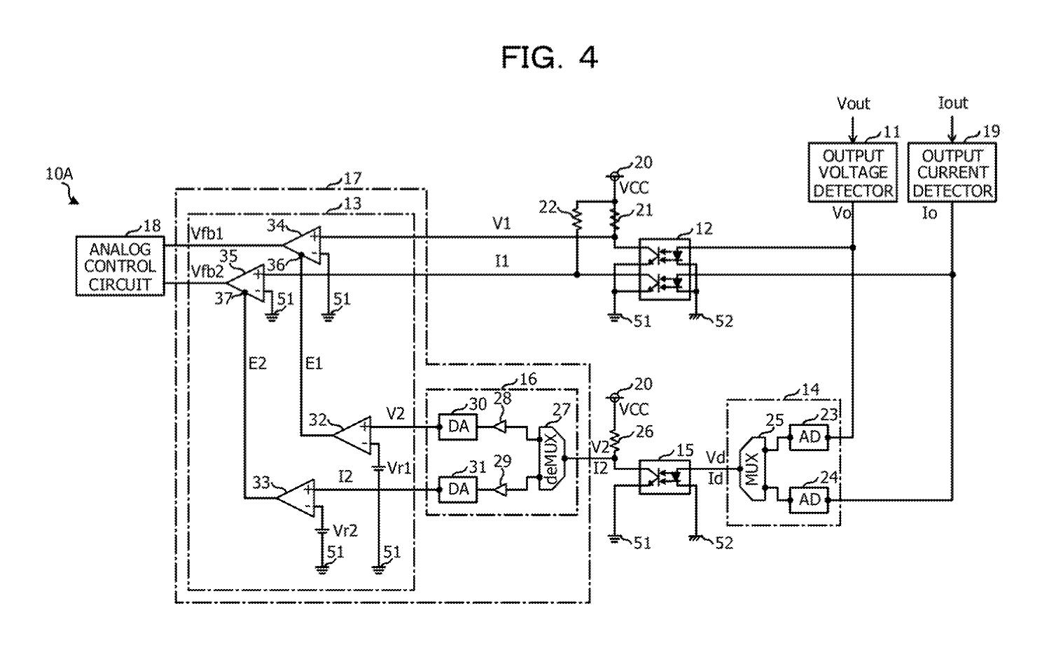

FIG. 4 is a diagram illustrating in detail an example of the configuration of the controller 10A of the power supply apparatus 101 according to the first embodiment. FIG. 4 illustrates an example in which the single common digital photo coupler 15 alternately transfers the detected value of the output voltage Vout output from the switching circuit 50 illustrated in FIG. 3 and a detected value of a current lout output from the switching circuit 50.

A high-speed analog output photo coupler is used as the analog photo coupler 12. If the analog photo coupler 12 monitors only the output voltage Vout, a single-channel photo coupler is used as the analog photo coupler 12. If the analog photo coupler 12 not only monitors the output voltage Vout but also monitors the output current lout for overcurrent protection, a double-channel photo coupler is used as the analog photo coupler 12. FIG. 4 exemplifies the case where the double-channel photo coupler is used. If a switching frequency and control frequency of the switching circuit 50 are set to 200 kHz, an example of the high-speed photo coupler used as the analog photo coupler 12 and provided for analog transfer is Fairchild Semiconductor HCPL2531.

An output current detector 19 detects the value of the current lout output from the switching circuit 50 and outputs an analog signal Io indicating the detected current value. The output current detector 19 outputs the analog signal Io by monitoring a voltage generated in a resistor in which the output current lout flows, for example. The analog signal Io is input to the analog photo coupler 12 and the AD converter 14.

The analog photo coupler 12 transfers the analog signal Vo as the analog first voltage detection signal V1 to the corrector 17. The analog photo coupler 12 electrically isolates the analog signal Vo by converting the analog signal Vo into light and transfers the analog signal Vo as the analog first voltage detection signal V1. Similarly, the analog photo coupler 12 transfers the analog signal Io as an analog first current detection signal I1 to the corrector 17. The analog photo coupler 12 electrically isolates the analog signal Io by converting the analog signal Io into light and transfers the analog signal Io as the analog first current detection signal I1.

An output terminal included in the analog photo coupler 12 and configured to output the first voltage detection signal V1 is coupled via a resistor 21 to a power supply 20 for supplying a direct-current power supply voltage VCC, while an output terminal included in the analog photo coupler 12 and configured to output the first current detection signal I1 is coupled via a resistor 22 to the power supply 20 for supplying the direct-current power supply voltage VCC.

The AD converter 14 includes two AD converters 23 and 24 and a single multiplexer (MUX) 25. The decoder 16 includes a single demultiplexer (deMUX) 27 and two digital-to-analog (DA) converters 30 and 31. The AD converter 14 and the decoder 16 may be achieved in a single-chip microcomputer (for example, Microchip PIC12F1501). For example, a serial output terminal of a first microcomputer including the AD converter 14 is coupled to an input terminal of the digital photo coupler 15, while a serial input terminal of a second microcomputer including the decoder 16 is coupled to an output terminal of the digital photo coupler 15.

The first AD converter 23 converts the analog signal Vo into the digital signal Vd. The second AD converter 24 converts the analog signal Io into a digital signal Id. The multiplexer 25 transmits any of the digital signals Vd and Id at predetermined intervals in serial transmission.

The digital photo coupler 15 transfers the input digital signal Vd as the digital second voltage detection signal V2 to the demultiplexer 27 of the decoder 16. Alternatively, the digital photo coupler 15 transfers the input digital signal Id as a digital second current detection signal I2 to the demultiplexer 27 of the decoder 16. An output terminal included in the digital photo coupler 15 and configured to output the second voltage detection signal V2 or the second current detection signal I2 is coupled via a resistor 26 to the power supply 20 for supplying the direct-current power supply voltage VCC. An example of a standard product used as the digital photo coupler 15 and provided for digital transmission is SHARP PC900VONSZXF of 100 kbps.

The decoder 16 includes a first buffer memory 28 inserted between the first DA converter 30 and the demultiplexer 27 and a second buffer memory 29 inserted between the second DA converter 31 and the demultiplexer 27.

The first buffer memory 28 holds the second voltage detection signal V2 input from the digital photo coupler 15 via the demultiplexer 27 for a first time period. The first time period includes a time period for which the second DA converter 31 transfers the second current detection signal I2 to a second differential amplifier 33 of the amplifying circuit 13 and a rest time period for which the AD converter 14 and the digital photo coupler 15 do not transfer the digital signals Vd and Id. Holding the second voltage detection signal V2 for the first time period may inhibit a first correction value E1 output from a differential amplifier 32 from changing within the first time period.

Similarly, the second buffer memory 29 holds the second current detection signal I2 input from the digital photo coupler 15 via the demultiplexer 27 for a second time period. The second time period includes a time period for which the first DA converter 30 transfers the second voltage detection signal V2 to the differential amplifier 32 of the amplifying circuit 13 and the rest time period for which the AD converter 14 and the digital photo coupler 15 do not transfer the digital signals Vd and Id. Holding the second current detection signal I2 for the second time period may inhibit a second correction value E2 output from the second differential amplifier 33 from changing within the second time period.

The rest time period corresponds to a time period for which the degradation of the analog photo coupler 12 is not monitored. If the AD converter 14 executes AD conversion (on only the voltage) once or (on the voltage and the current) twice within a cycle (of, for example, a day) in which the degradation of the analog photo coupler 12 is monitored (once, for example), the degradation of the analog photo coupler 12 may be monitored. Thus, the AD converter 14 may operate with a low-frequency clock and low consumption power.

The first DA converter 30 converts the digital second voltage detection signal V2 into the analog second voltage detection signal V2. The second DA converter 31 converts the digital second current detection signal I2 into the analog second current detection signal I2.

The amplifying circuit 13 includes the first differential amplifier 32, the second differential amplifier 33, a first variable gain amplifier 34, and a second variable gain amplifier 35.

The first differential amplifier 32 amplifies the difference between a voltage value indicated by the analog second voltage detection signal V2 and a first reference voltage value Vr1 and outputs the first correction value E1. The voltage value indicated by the analog second voltage detection signal V2 is an example of a value indicated by the second signal. The first reference voltage value Vr1 is an example of a value indicated by the first signal. The first reference voltage value Vr1 is set in advance based on the value initially output from the analog photo coupler 12 before the degradation of the analog photo coupler 12. Specifically, the first reference voltage value Vr1 corresponds to the voltage value indicated by the first voltage detection signal V1 output from the analog photo coupler 12 before the degradation of the analog photo coupler 12 in a state in which the value of the output voltage Vout matches the fixed target value Vref.

The second differential amplifier 33 amplifies the difference between a voltage value indicated by the analog second current detection signal 12 and a second reference voltage value Vr2 and outputs the second correction value E2. The second reference voltage value Vr2 is set in advance based on the value initially output from the analog photo coupler 12 before the degradation of the analog photo coupler 12. Specifically, the second reference voltage value Vr2 corresponds to the voltage value indicated by the first current detection signal I1 output from the analog photo coupler 12 before the degradation of the analog photo coupler 12 in a state in which the value of the output current Iout matches a fixed target value Iref.

The first variable gain amplifier 34 includes a gain adjusting circuit 36 configured to adjust, based on the first correction value E1, a gain A1 (amplification degree A1) by which the first voltage detection signal V1 is amplified. The first variable gain amplifier 34 outputs a feedback signal Vfb1 indicating a product of the first voltage detection signal V1 and the gain A1.

The second variable gain amplifier 35 includes a gain adjusting circuit 37 configured to adjust, based on the second correction value E2, a gain A2 (amplification degree A2) by which the first current detection signal I1 is amplified. The second variable gain amplifier 35 outputs a feedback signal Vfb2 indicating a product of the first current detection signal I1 and the gain A2.

An amplifying circuit for voltage conversion (for example, offsetting, amplification, linear correction, or the like) may be coupled to and between the first differential amplifier 32 and the first variable gain amplifier 34. An amplifying circuit for voltage conversion (for example, offsetting, amplification, linear correction, or the like) may be coupled to and between the second differential amplifier 33 and the second variable gain amplifier 35.

If the value of the output voltage Vout matches the fixed target value Vref, and the voltage value indicated by the first voltage detection signal V1 output from the analog photo coupler 12 before the degradation of the analog photo coupler 12 is V1a, the first reference voltage value Vr1 is set to V1a in advance. In this state, the following case (1) is considered: the voltage value indicated by the first voltage detection signal V1 output from the analog photo coupler 12 is reduced from V1a to V1b due to the degradation of the analog photo coupler 12 in the state in which the value of the output voltage Vout matches the fixed target value Vref.

In case (1), since the voltage value indicated by the analog second voltage detection signal V2 is reduced from V1a to V1b, the first differential amplifier 32 outputs the first correction value E1 corresponding to the reduced amount. The gain adjusting circuit 36 of the first variable gain amplifier 34 adjusts the value of the gain A1 from “A1a” to “A1a×V1a/V1b” based on the first correction value E1. Thus, even if the voltage value indicated by the first voltage detection signal V1 output from the analog photo coupler 12 is changed from V1a to V1b, the value of the first feedback signal Vfb1 is maintained at “A1a×V1a” before and after the change from V1a to V1b. Thus, even if the analog photo coupler 12 has degraded, the value of the first feedback signal Vfb1 does not change and the output voltage Vout may be maintained at the fixed target value Vref.

Similarly, if the voltage value indicated by the first current detection signal I1 output from the analog photo coupler 12 before the degradation of the analog photo coupler 12 in a state in which the value of the output current Iout matches the fixed target value Iref is I1a, the second reference voltage value Vr2 is set to I1a in advance. In this state, the following case (2) is considered: the voltage value indicated by the first current detection signal I1 output from the analog photo coupler 12 is reduced from I1a to I1b due to the degradation of the analog photo coupler 12 in the state in which the value of the output current Iout matches the fixed target value Iref.

In case (2), since the voltage value indicated by the analog second current detection signal I2 is reduced from I1a to I1b, the second differential amplifier 33 outputs the second correction value E2 corresponding to the reduced amount. The gain adjusting circuit 37 of the second variable gain amplifier 35 adjusts the value of the gain A2 from “A2a” to “A2a ×I1a/I1b” based on the second correction value E2. Thus, even if the voltage value indicated by the first current detection signal I1 output from the analog photo coupler 12 is changed from I1a to I1b, the value of the second feedback signal Vfb2 is maintained at “A2a ×I1a” before and after the change from I1a to I1b. Thus, even if the analog photo coupler 12 has degraded, the value of the second feedback signal Vfb2 does not change and the output current Iout may be maintained at the fixed target value Iref.

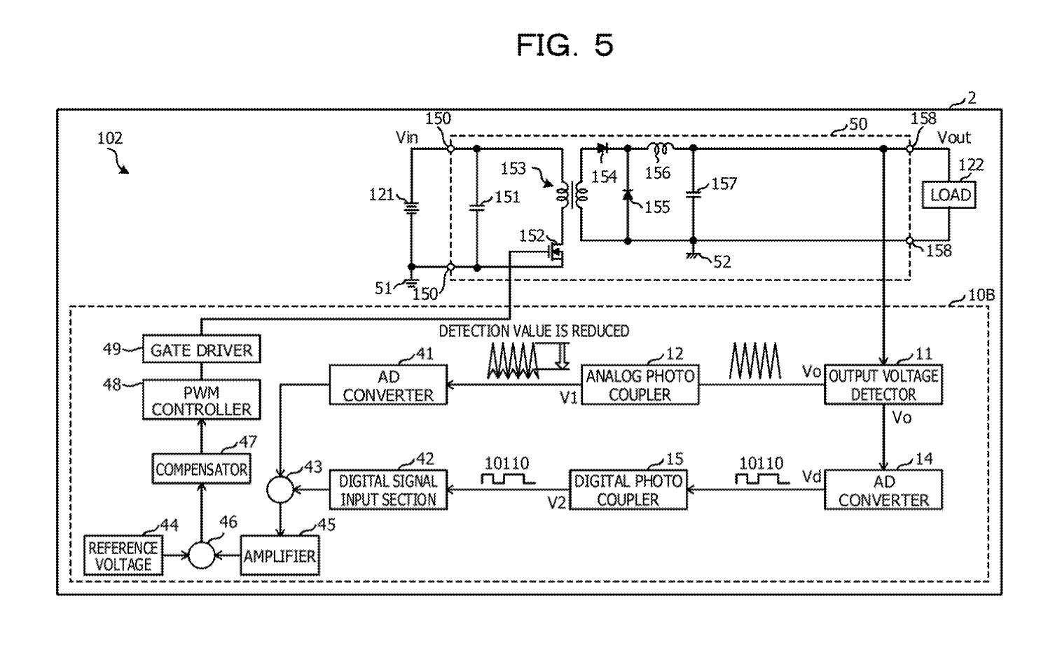

FIG. 5 is a diagram illustrating an example of the configuration of a power supply apparatus 102 according to a second embodiment. Descriptions of the same configurations and effects as those described in the first embodiment are omitted or simplified by using the aforementioned description. The power supply apparatus 102 is included in an electronic device 2 that is the same as or similar to the aforementioned electronic device 1. The power supply apparatus 102 includes a controller 10B. The controller 10B includes the output voltage detector 11, the analog photo coupler 12, the AD converter 14, and the digital photo coupler 15, like the aforementioned controller 10A. The controller 10B includes an AD converter 41, a digital signal input section 42, a correction calculator 43, an amplifier 45, an error calculator 46, a compensator 47, a pulse width modulation (PWM) controller 48, and a gate driver 49. A circuit that includes the AD converter 41, the digital signal input section 42, the correction calculator 43, and the amplifier 45 is an example of a corrector. A circuit that includes the error calculator 46, the compensator 47, the PWM controller 48, and the gate driver 49 is an example of a control circuit.

The AD converter 41 converts the analog first voltage detection signal V1 into the digital first voltage detection signal V1. The digital signal input section 42 supplies the digital second voltage detection signal V2 to the correction calculator 43. The correction calculator 43 calculates the difference E between a voltage value indicated by the digital first voltage detection signal V1 and a voltage value indicated by the digital second voltage detection signal V2. The amplifier 45 adjusts, based on the difference E, the gain A (amplification degree A) by which the first voltage detection signal V1 is amplified and the amplifier 45 outputs the feedback signal Vfb that is the first voltage detection signal V1 corrected based on the difference E.

The error calculator 46 calculates the difference between a reference voltage value 44 corresponding to the target value Vref of the output voltage Vout and the voltage value indicated by the feedback signal Vfb. The compensator 47 generates a duty ratio control value Dr for controlling the duty ratio D of the switching circuit 50 so that the difference between the reference voltage value 44 and the voltage value indicated by the feedback signal Vfb becomes zero. The duty ratio D of the switching circuit 50 indicates the duty ratio of the switching of the switching element 152 in the switching circuit 50. The PWM controller 48 outputs a PWM signal in accordance with the duty ratio control value Dr. The gate driver 49 switches the switching element 152 in accordance with the PWM signal.

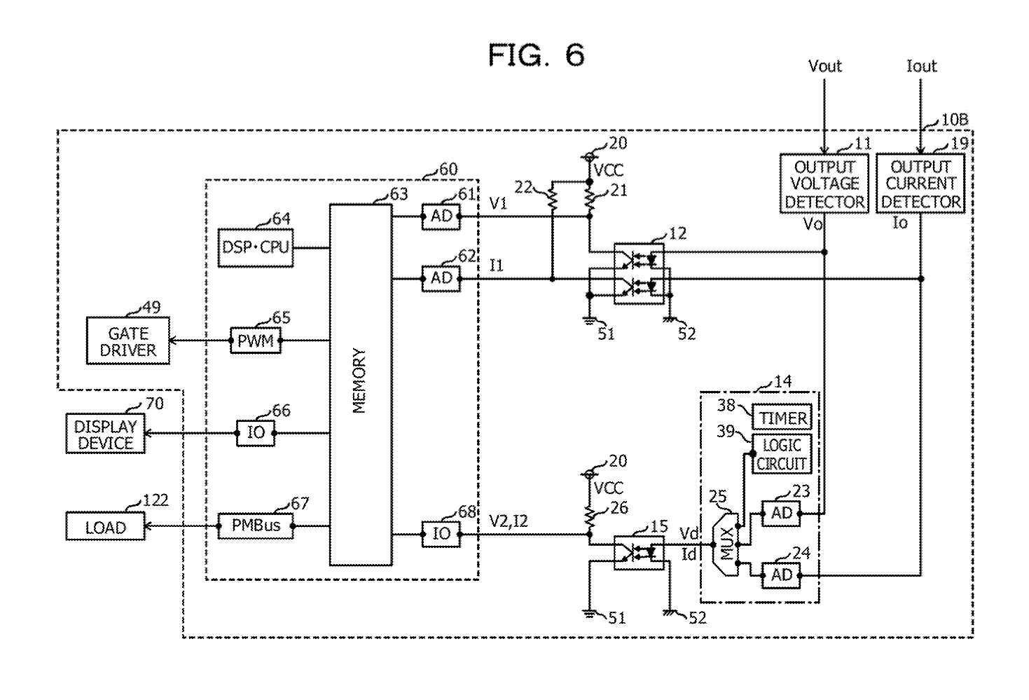

FIG. 6 is a diagram illustrating in detail an example of the configuration of the controller 10B of the power supply apparatus 102 according to the second embodiment. Descriptions of the same configurations and effects as those illustrated in and described with reference to FIG. 4 in the first embodiment are omitted or simplified by using the aforementioned description. The controller 10B includes a microcomputer 60 for controlling the power supply 20.

The microcomputer 60 includes AD converters 61 and 62, input and output (IO) ports 66 and 68, a memory 63, an arithmetic processor 64, a PWM module 65, and a power management bus (PMBus) 67. The arithmetic processor 64 includes a digital signal processor (DSP) and a central processing unit (CPU) or includes the DSP or the CPU. An example of the microcomputer 60 is Microchip dsPIC33FJ06GS101. A circuit that includes the AD converters 61 and 62, the IO ports 66 and 68, and the memory 63 is an example of the corrector. A circuit that includes the arithmetic processor 64 and the PMW module 65 is an example of the control circuit.

The arithmetic processor 64 causes digital data V1 (value indicated by the digital first voltage detection signal V1) obtained by converting the analog first voltage detection signal V1 by the AD converter 61 to be stored in the memory 63. The arithmetic processor 64 causes digital data I1 (value indicated by the digital first current detection signal I1) obtained by converting the analog first current detection signal I1 by the AD converter 62 to be stored in the memory 63.

The arithmetic processor 64 compares the stored digital data V1 and I1 with the target values Vref and Iref and executes compensation calculation to generate the duty ratio control value Dr. Then, the PWM module 65 controls the switching of the switching element 152 via the gate driver 49 in accordance with the duty ratio control value Dr. In this case, the target values Vref and Iref may be set as invariables or variables in the memory 63 in advance or may be values obtained by digitalizing other generated target values using the AD converters of the microcomputer 60.

The AD converter 14 includes the two AD converters 23 and 24, the single multiplexer (MUX) 25, an activation timer 38, and a communication logic circuit 39. The AD converter 14 may be achieved in a single microcomputer (for example, Microchip PIC12F1501).

The second voltage detection signal V2 digitalized by the first AD converter 23 and the second current detection signal I2 digitalized by the second AD converter 24 are alternately transferred via the digital photo coupler 15 in serial transmission. Then, the value (digital data V2) indicated by the digitalized second voltage detection signal V2 and the value (digital data I2) indicated by the digitalized second current detection signal I2 are stored in the memory 63 via the IO port 68 of the microcomputer 60.

The arithmetic processor 64 compares the digital data V2 transferred at intervals set in advance with the digital data V1 and calculates a correction coefficient C1 to be used for the correction of the first voltage detection signal V1 output from the analog photo coupler 12. The correction coefficient C1 corresponds to the first correction value E1 generated by the first differential amplifier 32 (refer to FIG. 4) of the aforementioned analog circuit.

Similarly, the arithmetic processor 64 compares the digital data I2 transferred at intervals set in advance with the digital data I1 and calculates a correction coefficient C2 to be used for the correction of the first current detection signal I1 output from the analog photo coupler 12. The correction coefficient C2 corresponds to the second correction value E2 generated by the second differential amplifier 33 (refer to FIG. 4) of the aforementioned analog circuit.

The arithmetic processor 64 uses the calculated correction coefficients C1 and C2 to correct gains (corresponding to the gains A1 and A2 used in the aforementioned analog circuit) to be used upon the compensation calculation. Thus, even if the sensitivity of the analog photo coupler 12 is reduced, the output voltage Vout may be maintained at the fixed value.

In FIG. 6, since the digital photo coupler 15 is a single-channel product, the AD converter 14 includes the timer 38 for the activation of a correction function and the communication logic circuit 39. However, if the digital photo coupler 15 is a bidirectional double-channel product, the microcomputer 60 for controlling the power supply 20 may control the AD conversion of the AD converter 14.

The microcomputer 60 may output, via the IO port 66 to a display device 70, one or more of the value of the corrected output voltage Vout, the value of the corrected output current Iout, and the estimated life (described later in detail) of the power supply apparatus 102. The microcomputer 60 may output, via the PMBus 67 to a device included in the load 122, an alarm indicating the occurrence of an abnormality of the electronic device 2 or indicating the possibility of the occurrence of an abnormality of the electronic device 2. The display device 70 may be included in the load 122.

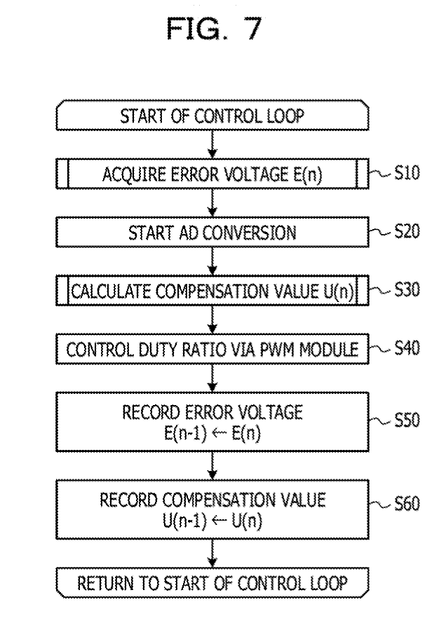

FIG. 7 is a flowchart of an example of a main control process to be executed by the microcomputer 60. Process steps illustrated in FIG. 7 are executed by the arithmetic processor 64 of the microcomputer 60. In step S10, the microcomputer 60 executes a process of acquiring an error voltage E(n).

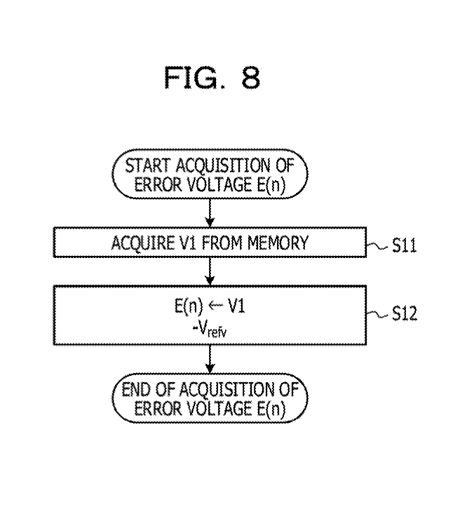

FIG. 8 is a flowchart of an example of the process of acquiring the error voltage E(n). In step S11, the microcomputer 60 acquires the digital data V1 from the memory 63. In step S12, the microcomputer 60 acquires, as the error voltage E(n), the difference between the digital data V1 acquired in step S11 and a target value V_{refv} (target value Vref set as a variable).

In step S20 illustrated in FIG. 7, the microcomputer 60 starts to execute the AD conversion on the first voltage detection signal V1 in advance in time for calculation to be executed in the next control loop. Intervals at which the control loop is executed is limited to a longer one of a time period for the calculation of a compensation value U(n) in step S30 and a time period for the execution of the AD conversion in step S20.

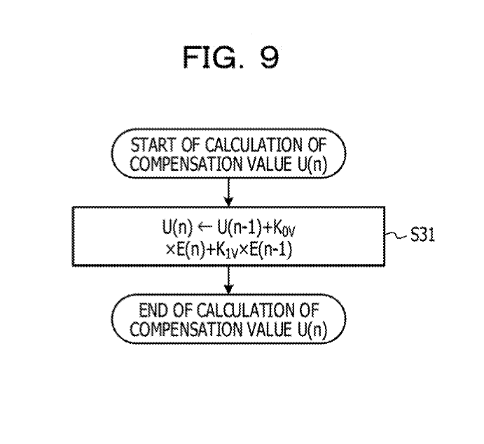

FIG. 9 is a flowchart of an example of a process of calculating the compensation value U(n). In step S31, the microcomputer 60 calculates “U(n−1)+K₀ᵥ×E(n)+K₁ᵥ×E(n−1)” as the compensation value U(n). U(n) indicates the compensation value in the current control loop, U(n−1) indicates the compensation value in the previous control loop, E(n) indicates the error voltage in the current control loop, and E(n−1) indicates the error voltage in the previous control loop. K₀ᵥ and K₁ᵥ indicate control variables to be used for proportional-integral-differential (PID) control. The compensation value U(n) corresponds to the aforementioned duty ratio control value Dr.

In step S40 illustrated in FIG. 7, the microcomputer 60 controls the duty ratio of the switching of the switching element 152 via the PWM module 65 in accordance with the compensation value U(n) calculated in step S30.

In step S50, the microcomputer 60 records the error voltage E(n) as an error voltage E(n−1) in the memory 63. In step S60, the microcomputer 60 records the compensation value U(n) as a compensation value U(n−1) in the memory 63.

In the process illustrated in FIGS. 7 to 9, since the digital data V1 newly acquired during the control loop is not directly corrected and the gains defined based on K₀ᵥ and K₁ᵥ are adjusted, the amount of data used for the calculation of the compensation value may be reduced.

The process illustrated in FIGS. 7 to 9 is applicable to the correction of digital data I1.

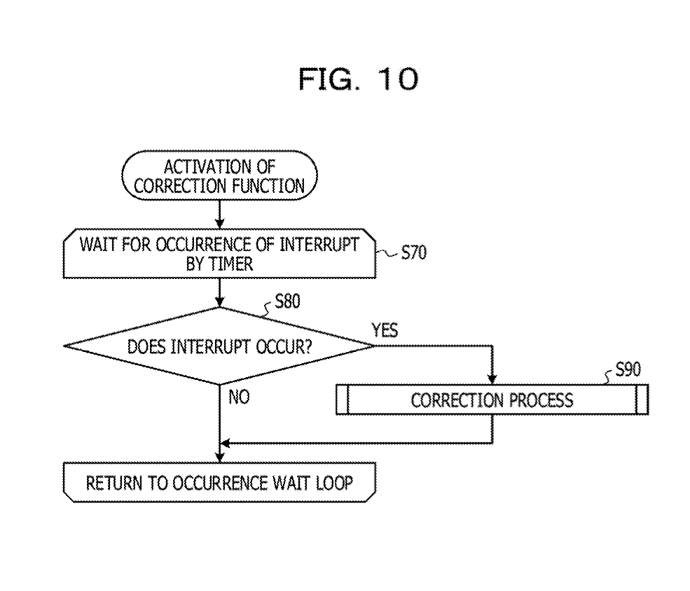

FIG. 10 is a flowchart of an example of a correction process to be executed by the AD converter 14. The AD converter 14 acquires the analog signals Vo and Io by interrupt processing caused by the timer 38 in order to support the case where the digital photo coupler 15 (refer to FIG. 5) is a unidirectional single-channel product.

In step S70, the AD converter 14 waits for the occurrence of an interrupt by the timer 38. If the interrupt occurs (Yes in step S80), the AD converter 14 executes the correction process using the digital data V2 and I2 (in step S90).

If the interrupt by the timer 38 is set to occur once at each of intervals of 28.1 hours, the interrupt by the timer 38 may occur so that the time when the interrupt occurs is shifted by 4.1 hours per day. Thus, even if a load variation periodically occurs, the setting of the interrupt may inhibit the correction process from being unable to be executed for a long time period due to synchronization with the load variation.

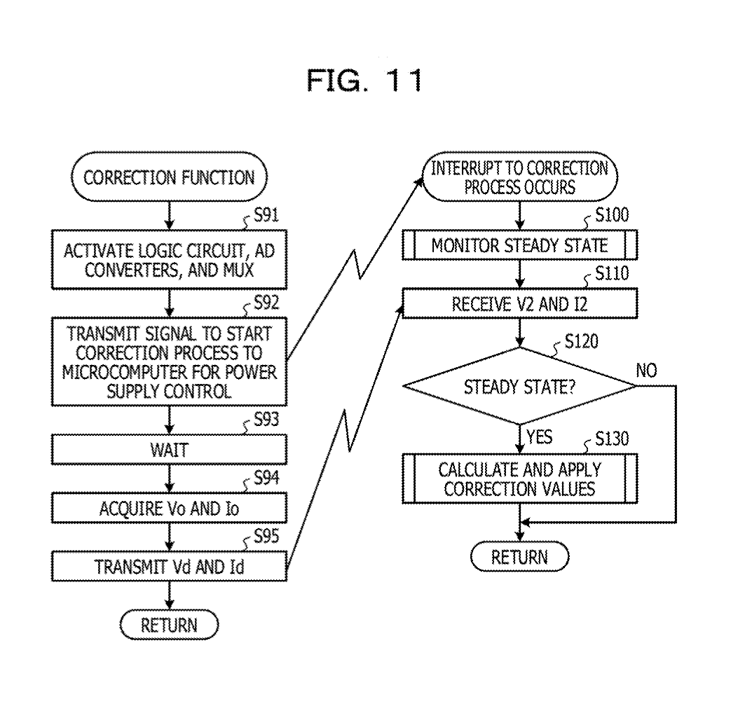

FIG. 11 is a flowchart of an example of a correction process to be executed by the AD converter 14 and the microcomputer 60. A flowchart illustrated on the left side in FIG. 11 indicates a correction process to be executed by the AD converter 14, while a flowchart illustrated on the right side in FIG. 11 indicates a correction process to be executed by the microcomputer 60.

In step S91, the logic circuit 39, the AD converters 23 and 24, and the multiplexer 25 are activated in response to the occurrence of the interrupt by the timer 38. The logic circuit 39, the AD converters 23 and 23, and the multiplexer 25 operate as the correction function.

In step S92, the AD converter 14 transmits, to the microcomputer 60 via the digital photo coupler 15, a signal to start the correction process using the digital data V2 and I2. The communication in step S92 is executed using an RS232 subset (two-wire asynchronous unidirectional communication). By reducing the communication rate, an effect on the main control loop may be suppressed. The same applies to communication in step S95 described later.

In step S93, the AD converter 14 waits until a predetermined time elapses. After that, in step S94, the AD converter 14 acquires the analog signals Vo and Io. In step S95, the AD converter 14 transmits the digital signals Vd and Id via the multiplexer 25. After the termination of the process of step S95, the process returns to step S70 illustrated in FIG. 10.

When receiving the signal, transmitted in step S92, to start the correction process, the microcomputer 60 determines that the interrupt to the correction process using the digital data V2 and I2 has occurred. In step S100, the microcomputer 60 executes a steady state monitoring process. The steady state monitoring process is a process of determining whether or not the current state is a steady state in step S120 described later.

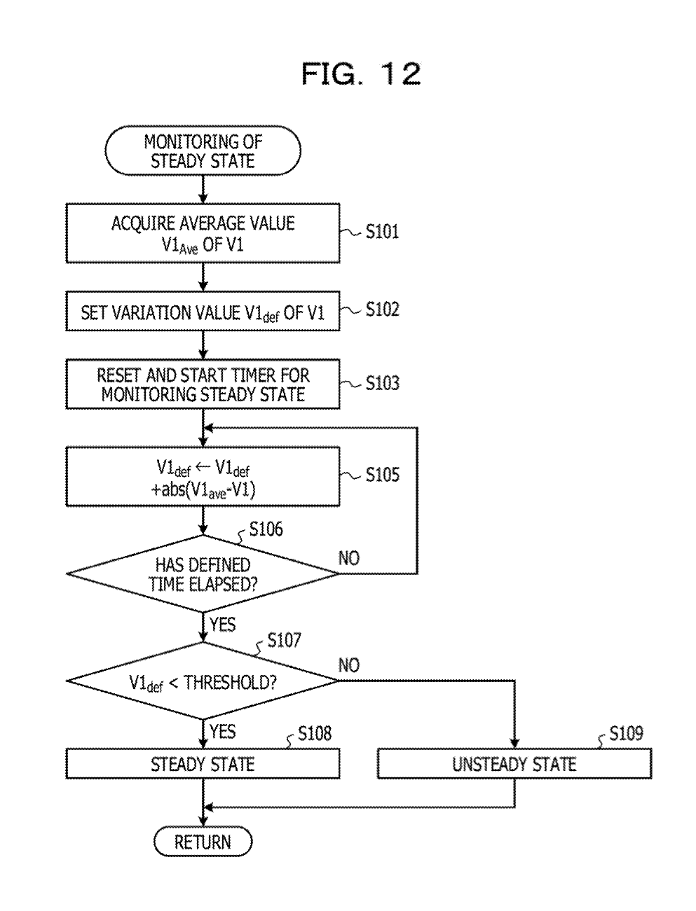

FIG. 12 is a flowchart of an example of the steady state monitoring process. Process steps illustrated in FIG. 12 are executed by the arithmetic processor 64 of the microcomputer 60.

In step S101, the microcomputer 60 acquires an average value V1_{Ave} of the digital data V1. The microcomputer 60 calculates the average value V1_{Ave} during the main control loop.

In step S102, the microcomputer 60 sets a variation value V1_{def} of the digital data V1 to zero. The variation value V1_{def} indicates a variation in the output voltage Vout.

In step S103, the microcomputer 60 resets a timer for monitoring the steady state and starts the counting of the timer for monitoring the steady state. In this timer, a time that is sufficiently longer than a response time set in the design of the power supply apparatus is set. For example, if the response time of the power supply apparatus is 1 millisecond (ms), a time of 2 ms is set in the timer.

In step S105, the microcomputer 60 calculates “V1_{def}+abs(V1_{Ave}−V1)” as the variation value V1_{def}. In this case, abs indicates a function for calculating the absolute value of an argument. A loop for acquiring the variation value V1_{def} is implemented as interrupt processing from the main control loop, and the addition process of step S105 is executed once for multiple cycles of the main control loop (ideally, for each cycle of the main control loop).

In step S106, the microcomputer 60 determines whether or not the defined time set in step S103 has elapsed. If the defined time has not elapsed, the process of step S105 is repeated. If the defined time has elapsed, a process of step S107 is executed.

In step S107, the microcomputer 60 determines whether or not the variation value V1_{def} is lower than a threshold. For example, the threshold is set to a value obtained by multiplying twice the least significant bit (LSB) of the digital value by the number of times when the addition process has been executed. If the variation value V1_{def} is lower than the threshold, the microcomputer 60 determines that the state of the current output voltage Vout is the steady state in which a variation in the output voltage Vout is relatively small (in step S108). On the other hand, if the variation value V1_{def} is not lower than the threshold, the microcomputer 60 determines that the state of the current output voltage Vout is an unsteady state in which the variation in the output voltage Vout is relatively large (in step S109).

After the processes of steps S108 and S109, the process proceeds to step S110 illustrated in FIG. 11.

In step S110, the microcomputer 60 receives the second voltage detection signal V2 corresponding to the digital signal Vd transmitted in step S95 and the second current detection signal I2 corresponding to the digital signal Id transmitted in step S95.

In step S120, the microcomputer 60 determiners whether or not the current state, acquired in step S100, of the output voltage Vout is the steady state. If the current state is the steady state, the microcomputer 60 executes a process of calculating and applying correction values R1 and R2 (in step S130). If the current state is not the steady state, the process of step S130 is not executed and the microcomputer 60 waits for the interrupt to the correction process.

If the second voltage detection signal V2 or the second current detection signal I2 is transmitted in step S110 and the microcomputer 60 determines that the current state is the unsteady state, the microcomputer 60 does not change the correction values or maintains the correction values at previous values. Thus, if the output voltage Vout varies upon a rapid change in the load or the like, erroneous values are inhibited from being set due to the acquisition of the correction values.

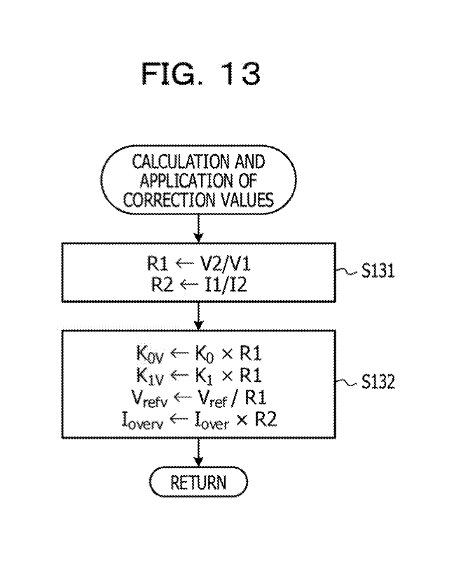

FIG. 13 is a flowchart of an example of the process of calculating and applying the correction values R1 and R2. Process steps illustrated in FIG. 13 are executed by the arithmetic processor 64 of the microcomputer 60.

In step S131, the microcomputer 60 calculates “V2/V1” as the correction value R1 to be used for the correction of a deviation, caused by the degradation of the analog photo coupler 12, of the output voltage Vout. In addition, the microcomputer 60 calculates “I1/I2” as the correction value R2 to be used for the correction of a deviation, caused by the degradation of the analog photo coupler 12, of the output current lout.

In step S132, the microcomputer 60 calculates K₀×R1 as the control variable K₀ᵥ for the PID control, calculates K₁×R1 as the control variable K₁ᵥ for the PID control, and calculates V_{ref}/R1 as the target value V_{refv}. K₀ and K₁ indicate fixed control values to be used for the PID control. V_{ref} indicates a fixed value.

In the acquisition of the digital data V1 by the AD conversion, the calculation load may be reduced by multiplying the fixed values K₀ and K₁ by R1 and multiplying the fixed value V_{ref} by “1/R1” during the main control loop, instead of multiplication by R1 in each cycle of the main control loop.

In step S132, the microcomputer 60 calculates Iₒᵥₑᵣ×R2 as Iₒᵥₑᵣᵥ. Iₒᵥₑᵣ and Iₒᵥₑᵣᵥ indicate thresholds for overcurrent protection. The calculation load may be reduced by multiplying the fixed value Iₒᵥₑᵣ by R2.

For the transmission of the value of the output voltage Vout and the value of the output current lout to the device included in the load 122 via a communication bus such as the PMBus 67, high-speed performance is not requested, unlike the calculation of the correction values and the overcurrent protection. Thus, the microcomputer 60 may multiply the digital data V1 and I1 by R1 and R2 to correct the digital data V1 and I1 upon the transmission of the value of the output voltage Vout and the value of the output current lout to the device included in the load 122 via the communication bus such as the PMBus 67.

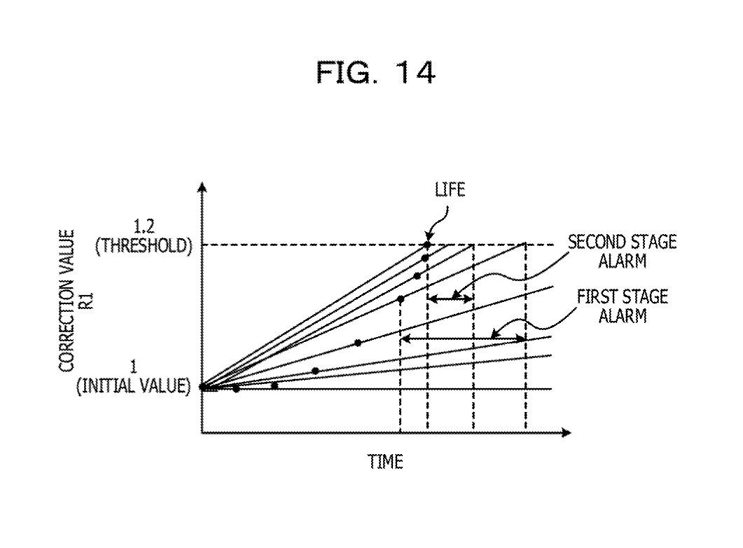

Next, a process of estimating the life is described. FIG. 14 is a diagram illustrating an example of the relationship between time and the correction value R1.

As an example, a time period to the time when the sensitivity of the analog photo coupler 12 is reduced by 20% from an initial value of the sensitivity upon the initial use of the power supply apparatus 102 is defined as the life. If the life is not estimated and the output voltage Vout increases by 20%, the analog photo coupler 12 reaches end of life upon the increase in the output voltage Vout by 20% and becomes out of specification.

When the difference between the current time and the time when extrapolated data obtained by extrapolating the current correction value R1 with respect to an operational time of the power supply apparatus exceeds a threshold becomes a time of less than one month, the microcomputer 60 generates a first stage alarm. When the time difference becomes a time of less than one week, the microcomputer 60 generates a second stage alarm.

In this example, the correction value is extrapolated using linear approximation from the initial value obtained upon the initial use of the power supply apparatus 102. The accuracy, however, may be improved by extrapolating the correction value based on the difference between the current value of the correction value and the previous value of the correction value.

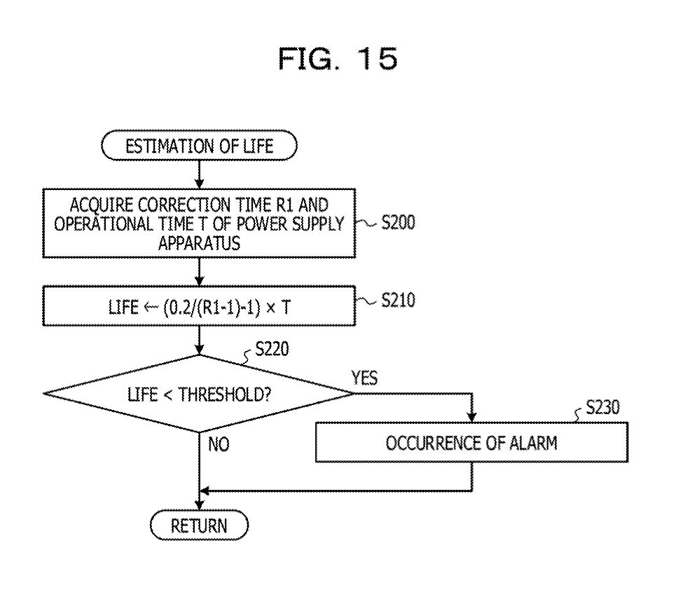

FIG. 15 is a flowchart of an example of the process of estimating the life by the microcomputer 60. This life estimation routine is periodically executed as interrupt processing from the main control loop. Process steps illustrated in FIG. 15 are executed by the arithmetic processor 64 of the microcomputer 60.

In step S200, the microcomputer 60 acquires the correction value R1 and an operational time T of the power supply apparatus 102 T from the initial use of the power supply apparatus 102.

In step S210, the microcomputer 60 calculates “(0.2/(R1−1)−1)×T” as the life. This formula indicates the case where the time period to the time when the sensitivity of the analog photo coupler 12 is reduced by 20% from the initial value of the sensitivity upon the initial use of the power supply apparatus 102 is defined as the life.

In step S220, the microcomputer 60 determines whether or not the life calculated in step S210 is lower than a threshold. If the microcomputer 60 determines that the life calculated in step S210 is not lower than the threshold, the microcomputer 60 does not generate an alarm. If the microcomputer 60 determines that the life calculated in step S210 is lower than the threshold, the microcomputer 60 generates the alarm (in step S230).

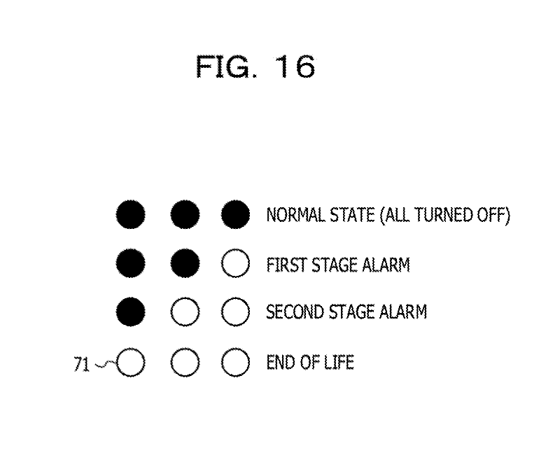

FIG. 16 is a diagram illustrating an example of a display state. The electronic device 2 includes multiple light emitting diodes 71 as the display device 70 (refer to FIG. 6). The microcomputer 60 sequentially causes multiple light emitting diodes 71 to light up upon the generation of an alarm. Every time the microcomputer 60 generates an alarm, the microcomputer 60 changes the number of light emitting diodes 71 turned on (or increases the number of light emitting diodes 71 that light up, for example).

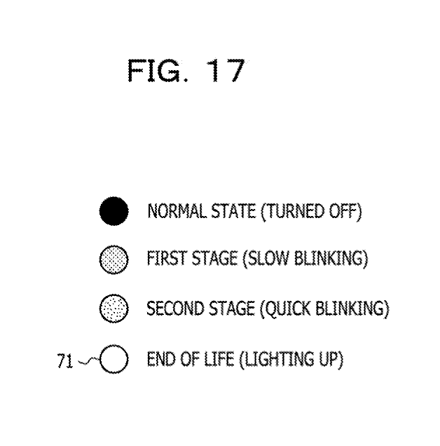

FIG. 17 is a diagram illustrating an example of the display state. The electronic device 2 includes a single light emitting diode 71 as the display device 70 (refer to FIG. 6). The microcomputer 60 causes the light emitting diode 71 light up or blink upon the generation of an alarm. Every time the microcomputer 60 generates an alarm, the microcomputer 60 changes how the light emitting diode 71 lights up or blinks. For example, the microcomputer 60 increases the blinking speed of the light emitting diode 71 as the remaining life is reduced.

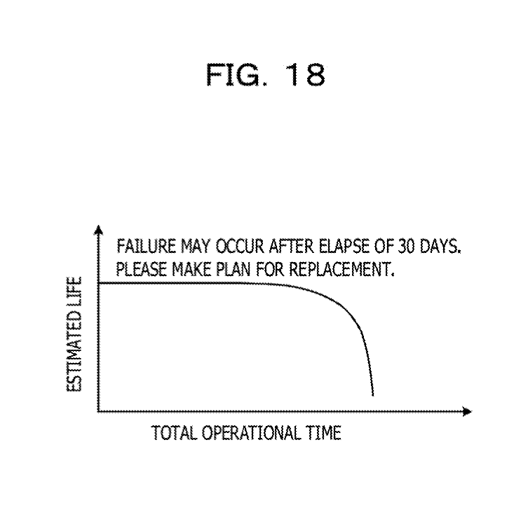

FIG. 18 is a diagram illustrating an example of the display state. The electronic device 2 includes a display as the display device 70 (refer to FIG. 6). The microcomputer 60 transfers the correction value R1 via the PMBus 67 to a display control device (that is an example of the device included in the load 122) configured to control the displaying of the display device 70. The display control device causes the remaining life and a life curve to be displayed in the display.

In the display states illustrated in FIGS. 16 to 18, the remaining life of the electronic device 2 that depends on the degradation of the power supply apparatus 102 (specifically, analog photo coupler 12) may be visually recognized by a user.

Although the power supply apparatuses and the electronic devices are described above, the present disclosure is not limited to the aforementioned embodiments. Various changes and modifications such as a combination and replacement of a part or all of any of the embodiments with a part or all of the other embodiment may be made within the scope of the disclosure.

For example, the first photo coupler (analog photo coupler 12 in the embodiments) may be an analog input and digital output element. The second photo coupler (digital photo coupler 15 in the embodiments) may be a digital input and analog output element.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A power supply apparatus comprising:
a DC-DC converter configured to convert an input voltage into an output voltage in accordance with a duty cycle which is decided by a difference of a third signal;
a first photo coupler configured to output a first signal corresponding to the output voltage;
a converter configured to convert the output voltage into a digital signal; and
a second photo coupler configured to output a second signal corresponding to the digital signal;
a memory; and
a processor coupled to the memory and configured to:
calculate a third signal on the basis of the difference between the first signal and the second signal; and
control the DC-DC converter so that the third signal is to be zero.

2. The power supply apparatus according to claim 1,
wherein intervals at which the second photo coupler transfers the second signal are longer than intervals at which the first photo coupler transfers the first signal.

3. The power supply apparatus according to claim 1,
wherein the rate of outputting the second signal from the second photo coupler is lower than the rate of outputting the first signal from the first photo coupler.

4. The power supply apparatus according to claim 1,
wherein a power supply voltage to be supplied to the converter and the second photo coupler or supplied to the converter or the second photo coupler is blocked for a time period for which the second photo coupler does not transfer the second signal.

5. The power supply apparatus according to claim 1,
wherein the processor adjusts, based on the difference, the degree at which the first signal is amplified.

6. The power supply apparatus according to claim 1,
wherein the processor corrects the first signal output from the first photo coupler, based on the addition of the first signal output from the first photo coupler to the difference.

7. An electric device comprising:
a DC-DC converter configured to convert an input voltage into an output voltage in accordance with a duty cycle which is decided by a difference of a third signal;
a first photo coupler configured to output a first signal corresponding to the output voltage;
a converter configured to convert the output voltage into a digital signal; and
a second photo coupler configured to output a second signal corresponding to the digital signal;
a memory;
a processor coupled to the memory and configured to:
calculate a third signal on the basis of the difference between the first signal and the second signal,
control the DC-DC converter so that the third signal is to be zero, and
predict a life of the first photo coupler on the basis of the first signal; and
a display configured to display information of the life.
